(19) United States
(12) Patent Application Publication
(10) Pub. No.: US 2025/0220800 A1
(43) Pub. Date: Jul. 3, 2025

(54) Apparatus and Method for the Reduction of Oxides on Workpiece Surfaces

(71) Applicant: Plasmatreat GmbH, Steinhagen (DE)

(72) Inventors: Christian Buske, Bielefeld (DE); Magnus Buske, Steinhagen (DE); Adrian Druben, Lichtenau (DE); Pascal Holste, Bielefeld (DE); Yaser Hamedi, Bielefeld (DE)

(21) Appl. No.: 18/851,929

(22) PCT Filed: Mar. 28, 2023
(86) PCT No.: PCT/EP2023/057898

§ 371 Date: Sep. 27, 2024

(30) Foreign Application Priority Data
Mar. 31, 2022 (DE) 10 2022 107 650.4

(51) Int. Cl. H05H 1/26; H05H 1/24

(52) U.S. Cl. CPC H05H 1/26; H05H 1/2406; H05H 2245/40

(57) ABSTRACT

The invention relates to an apparatus for the reduction of oxides on workpiece surfaces, with a treatment tunnel extending from an inlet opening to an outlet opening, with a reaction region arranged within the treatment tunnel with a plasma nozzle which is configured to generate an atmospheric plasma jet, with a reduction gas supply configured to introduce a reduction gas into the reaction region, and with a transport device configured to transport workpieces through the treatment tunnel. The plasma nozzle is arranged and configured in such a way as to introduce the atmospheric plasma jet into the reaction region during operation. The invention further relates to the use of the apparatus and a method for the reduction of oxides on workpiece surfaces.

### CROSS-REFERENCE TO RELATED APPLICATIONS

This application is the United States national phase of International Patent Application No. PCT/EP2023/057898 filed Mar. 28, 2023, and claims priority to German Patent Application No. 10 2022 107 650.4 filed Mar. 31, 2022, the disclosures of which are hereby incorporated by reference in their entireties.

### BACKGROUND OF THE INVENTION

### Field of the Invention

The present invention relates to an apparatus and a method for the reduction of oxides on workpiece surfaces. The invention further relates to the use of such an apparatus.

### Description of Related Art

It is known from the state of the art to reduce oxides on metallic workpiece surfaces using low-pressure plasma. For example, oxides on workpiece surfaces are reduced in order to achieve better wettability of the workpiece surfaces or to be able to produce an electrically conductive connection, for example a soldered connection. This is particularly advantageous for subsequent process steps on the workpieces, such as bonding or soldering to other workpieces. A method for removing oxides by means of low-pressure plasma treatment is described in WO 00/29642 A1, for example. However, such low-pressure methods have the disadvantage that they can only be integrated into a continuous production operation with a great deal of technical effort due to the loading and unloading operations required.

There have also been attempts to use atmospheric plasma for the reduction of metal surfaces. However, these attempts partly did not bring about the desired performance.

### SUMMARY OF THE INVENTION

Against this background, the present invention is based on the object of providing an improved apparatus and an improved method for the reduction of oxides on workpiece surfaces, which are particularly suitable for inline use.

According to the invention, this object is solved by an apparatus for the reduction of oxides on workpiece surfaces, with a treatment tunnel extending from an inlet opening to an outlet opening, with a reaction region arranged within the treatment tunnel, with a plasma nozzle which is configured to generate an atmospheric plasma jet, with a reduction gas supply configured to introduce a reduction gas into the reaction region, and with a transport device configured to transport workpieces through the treatment tunnel, wherein the plasma nozzle is arranged and configured in such a way as to introduce the atmospheric plasma jet into the reaction region during operation.

By introducing the plasma jet into the reaction region, the gas volume in the reaction region can be excited or activated so that oxides on the workpiece surface of workpieces transported through the reaction region are reduced.

Preferably, the plasma nozzle is also arranged and configured in such a way that workpieces, which are transported through the treatment tunnel with the transport device during operation, are exposed to the atmospheric plasma jet in the reaction region. By directing the atmospheric plasma jet onto the workpieces during operation, the effect of the plasma jet on the workpiece surface can be intensified and more effective oxide reduction can be achieved. In addition, by exposing the workpieces to the plasma jet, the heat input into the workpieces during reduction can be increased, which accelerates the reduction treatment.

It has been found that one problem with the reduction of metal surfaces using plasma in inline operation lies in the fact that workpiece surfaces reduced using plasma have a strong tendency to re-oxidize, particularly immediately after plasma treatment, so that the effects of the previous reduction are diminished. In particular, tests have shown that exposing a metal surface to an atmospheric plasma jet to reduce oxides causes the metal surface to heat up significantly, which favors subsequent re-oxidation in an oxygen-containing atmosphere. Furthermore, the interaction of the atmospheric plasma with the metal surface can lead to a modification, in particular activation, of the metal surface, which favors re-oxidation.

By arranging the reaction region, into which an atmospheric plasma jet is introduced, in particular in which a workpiece surface of a workpiece is preferably exposed to an atmospheric plasma jet for the reduction of oxides, within a treatment tunnel through which the workpiece is transported by means of a transport device, an apparatus for the reduction of oxides on workpiece surfaces by means of plasma is provided which can be easily integrated into a continuously operating inline process, in particular a manufacturing process. In particular, the workpieces to be treated can be transported through the reaction region one after the other in a controlled manner and subjected to the reduction treatment there. On the other hand, the reaction region is shielded from the direct influence of the environment by the treatment tunnel. In this way, the environmental conditions acting on a treated workpiece in the reaction region and in the part of the treatment tunnel following the reaction region can be better controlled, so that re-oxidation processes can be reduced. In particular, it is easier to maintain a reducing and low-oxygen or oxygen-free atmosphere in the reaction region and in the following part of the treatment tunnel in order to reduce or prevent reoxidation of the workpiece surface immediately after the reduction treatment.

The apparatus may in particular have a housing, for example a metal housing, which forms the treatment tunnel. During operation, the workpieces to be treated enter the treatment tunnel through the inlet opening and leave it again through the outlet opening after treatment in the reaction region. Compared to vacuum or low-pressure-based treatment apparatuses, there is no need for loading and unloading processes, making the apparatus very suitable for inline operation. The inlet opening and/or the outlet opening may be designed as simple openings through which the workpieces to be treated can enter and leave the treatment tunnel. In order to separate the atmosphere in the treatment tunnel even better from the environment, a curtain, for example a strip curtain, may optionally be provided at the inlet opening and/or at the outlet opening.

In particular, the treatment tunnel is essentially at atmospheric pressure. In order to reduce or prevent oxygen-containing air from the environment from entering the treatment tunnel, there may also be a slight overpressure in the treatment tunnel compared to the ambient pressure. The overpressure may be created, for example, via the reduction gas supply or via a separate gas supply, such as a purge gas supply.

The treatment tunnel preferably has at least a predetermined minimum length between the input opening and the reaction region and/or between the reaction region and the output opening, which may be, for example, 5 cm, preferably 10 cm, more preferably 20 cm. For example, the distance between the input opening and the reaction region and/or between the reaction region and the output opening may be in the range of 5 to 50 cm. In this way, the influence of the ambient atmosphere on the workpiece during or shortly after the reduction treatment is reduced. Preferably, the minimum length is greater than the height of the treatment tunnel.

The treatment tunnel may, for example, have a width of a few centimetres, for example 10 cm, up to several metres, for example 3 m, and/or a height of a few centimetres, for example 5 cm, up to several tens of centimetres, for example 20 cm. In particular, the dimensions of the treatment tunnel may be adapted to the dimensions of the workpieces to be treated.

Between the inlet opening and the reaction region and/or between the reaction region and the outlet opening, the treatment tunnel preferably has a reduced cross-section compared to the reaction region. In this way, the influence of the ambient atmosphere on the workpiece during or shortly after the reduction treatment can be further reduced.

The plasma nozzle is configured to generate an atmospheric plasma jet. For this purpose, the plasma nozzle preferably has a working gas supply for supplying the plasma nozzle with a working gas and a nozzle opening from which the plasma jet emerges during operation. The atmospheric plasma jet operates in the atmospheric pressure range, in particular at ambient pressure or a slight overpressure. This eliminates the need for complex negative pressure environments. In order to apply the atmospheric plasma jet to workpieces, which are transported through the treatment tunnel with the transport device, in the reaction region during operation, the plasma nozzle may preferably be arranged in or at the reaction region. For example, the housing of the apparatus may have a receptacle in the reaction region into which the plasma nozzle is inserted. Furthermore, the treatment tunnel in the reaction region may have a plasma jet inlet opening which is connected to a nozzle opening of the plasma nozzle so that the plasma jet can enter the reaction region during operation. The plasma jet inlet opening and/or the nozzle opening of the plasma nozzle are preferably arranged such that, during operation, the plasma jet is directed towards an area of the transport device in which workpieces are transported through the reaction region.

In particular, the transport device is configured to transport workpieces to be treated from the inlet opening through the treatment tunnel to the outlet opening. For example, the transport device may be designed as a conveyor belt on which the workpieces to be treated can be transported from the inlet opening through the treatment tunnel to the outlet opening. The transport device may be part of a larger transport system of an inline process with several stations. For example, it is conceivable that a conveyor belt is provided with which workpieces are transported through various processing and/or treatment stations, one station of which being the apparatus described herein for the reduction of oxides on workpiece surfaces.

The transport device preferably has a drive with an adjustable transport speed. In this way, the treatment time of the workpieces in the reaction region may be specifically adjusted. Good reduction results on workpiece surfaces have been achieved, for example, at a transport speed in the range of 0.1-10 m/min, in particular in the range of 0.3-0.6 m/min. The transport device may be configured to transport the workpieces through the treatment tunnel at a constant speed. Alternatively, the transport device may be configured to slow down the transport of the workpieces in certain areas of the treatment tunnel, for example in the reaction region, or to stop it for a certain period of time. In this way, the reduction treatment of the workpieces can be influenced.

The reduction gas supply is configured to introduce a reduction gas into the reaction region. For this purpose, the reduction gas supply may in particular have a reduction gas source for providing a reduction gas, for example a gas cylinder with a reduction gas, as well as a reduction gas line through which the reduction gas is introduced from the reduction gas source into the reaction region. The reduction gas supply may be configured to introduce the reduction gas into the reaction region at a predetermined or predeterminable gas supply rate. For this purpose, the reduction gas supply may have an adjustable valve, for example. In this way, the gas supply rate may be adjusted in a targeted manner, for example adapted to the material of the workpieces to be treated and/or adapted as a function of the speed of the transport device. Suitable gas supply rates may, for example, be in a range of 5-50 l/min, preferably 20-40 l/min, particularly preferably approx. 35 l/min, so that sufficient reduction gas can be made available for the reduction and reoxidation can be prevented at the same time.

The reduction gas is preferably a hydrogen-containing gas, for example a mixture of hydrogen and an inert gas such as nitrogen or argon.

It has been found that, if dissociated hydrogen is provided on an oxidized metal surface by a plasma process, the reduction of metals can be carried out at relatively low temperatures. In this way, workpiece surfaces of metals with a low melting point, for example tin with a melting point of around 230° C., can be effectively reduced.

A hydrogen content of the reduction gas of 1 to 10 vol.-%, preferably 2 to 5 vol.-%, has proven to be particularly advantageous for the effective reduction of oxides on workpiece surfaces, especially metallic workpiece surfaces. Further components of the working gas may also be nitrogen and argon in particular. Inert gases are in particular advantageous as working gases, as they only hardly participate in chemical reactions and are therefore well suited as a carrier gas, for example for hydrogen as a reduction gas. Forming gas, for example, with a hydrogen content (H₂) of 5 vol.-% and a nitrogen content (N₂) of 95 vol.-%, may be considered as a reduction gas.

The reduction gas is in particular oxygen-free or has an oxygen content of less than 1 vol.-%, in particular less than 0.3 vol.-%.

Furthermore, the above-mentioned object is solved according to the invention by using the apparatus described above or an embodiment thereof for the reduction of oxides on workpiece surfaces, in particular metallic workpiece surfaces.

The above object is further solved according to the invention by a method for the reduction of oxides on workpiece surfaces using the apparatus described above or an embodiment thereof, in which one or more workpieces are transported through the treatment tunnel by the transport device, in which an atmospheric plasma jet is generated with the plasma nozzle, in which a reduction gas is introduced into the reaction region, and in which the atmospheric plasma jet is introduced into the reaction region.

Preferably, the one or more workpieces transported through the treatment tunnel are exposed to the atmospheric plasma jet in the reaction region.

In particular, the apparatus and the method serve for the reduction of oxides on at least partially metallic workpiece surfaces of a workpiece that consists at least partially of metal or a metal alloy. The metal may, for example, be aluminum, copper, silver, iron, nickel, titanium, chromium, or tin. Further preferably, the apparatus is used in an inline process in which the treated workpiece surface is subsequently subjected to a soldering process.

It was found that by using the apparatus or method according to the invention for the reduction of oxides on workpiece surfaces to be soldered, improved wetting of the workpiece surface with solder is achieved, so that less flux has to be used or can even be dispensed with altogether. This allows soldering processes that are more environmentally friendly, less hazardous to health and more cost-effective.

Various embodiments of the apparatus, its use and the method are described below, with the individual embodiments each applying independently of one another to the apparatus, its use and the method. In addition, the individual embodiments may be combined with one another.

In one embodiment, the plasma nozzle is configured to generate an atmospheric plasma jet by means of a high-frequency, high-voltage discharge, in particular between at least two electrodes. In particular, the plasma nozzle may be configured to generate the plasma jet by means of a high-frequency arc-like discharge in a working gas. A plasma jet generated in this way can be easily aligned and has proven to be very efficient in reducing oxides on metallic surfaces.

In particular, at least two electrodes may be provided to generate the arc-like electrical discharge, as well as a voltage source to apply a high-frequency high voltage to the electrodes. The high-frequency high voltage for generating a high-frequency arc-like discharge has, in particular, a voltage strength in the range of 1-100 kV, preferably 1-50 kV, more preferably 10-50 kV, and a frequency of 1-300 kHz, in particular 1-100 kHz, preferably 10-100 kHz, more preferably 10-50 kHz.

Furthermore, the plasma nozzle may be configured to generate the atmospheric plasma jet by means of dielectric barrier discharge (DBD). Due to the low temperature of the plasma jet generated by means of DBD, this form of discharge is particularly suitable for the treatment of temperature-sensitive surfaces. To generate the dielectric barrier discharge, at least two electrodes and a dielectric arranged between them may be provided in particular, which dielectric impedes a direct electrical discharge between the two electrodes. Preferably, one of the electrodes is grounded. Furthermore, a voltage source is provided in particular to apply a high-frequency high voltage to the electrodes, for example with a voltage strength in the range from 5 to 15 kV and a voltage frequency in the range from 7.5 to 25 kHz, in particular 13 to 14 kHz.

In a further embodiment of the apparatus, the reduction gas supply is configured to supply the reduction gas to the plasma nozzle as a working gas. In a corresponding embodiment of the method, the reduction gas is fed into the plasma nozzle as a working gas. In this way, the reduction gas can be introduced directly through the plasma nozzle into the reaction region, so that a separate reduction gas inlet opening from the plasma nozzle into the reaction region can be dispensed with. However, it is also conceivable that the reduction gas supply has a reduction gas inlet opening separate from the plasma nozzle in order to introduce the reduction gas into the reaction region. By supplying the reduction gas to the plasma nozzle as a working gas, a strong excitation of the reduction gas in the plasma nozzle occurs, whereby a strong reducing effect is achieved.

In a further embodiment of the apparatus, the reduction gas supply is configured to introduce the reduction gas into the reaction region through a reduction gas inlet opening that is separate from the plasma nozzle. In a corresponding embodiment of the method, the reduction gas is introduced into the reaction region via a reduction gas inlet opening that is separate from the plasma nozzle. In this way, the reduction gas flow may be adjusted independently of the working gas flow of the plasma nozzle. Furthermore, the working gas of the plasma nozzle may be freely selected in this way. For example, an inert gas may be used as the working gas of the plasma nozzle in this way in order to extend the service life of the plasma nozzle. However, it is also conceivable that the reduction gas supply is configured to supply the reactive gas both to the plasma nozzle as a working gas and to introduce it into the reaction region via a reduction gas inlet opening separate from the plasma nozzle.

The reduction gas supply is preferably configured to introduce the reduction gas into the reaction region under atmospheric pressure or under overpressure. In this way, the reaction region can be effectively filled with reduction gas so that, in particular, the workpieces transported through the reaction region during operation are surrounded by the gas to be reduced.

In a further embodiment, a purge gas supply is provided, which is configured to introduce a purge gas into the treatment tunnel, in particular into the reaction region. Preferably, the purge gas supply is configured to introduce the purge gas into the treatment tunnel, in particular into the reaction region, under atmospheric pressure or under overpressure. The purge gas may be used to purge the treatment tunnel, in particular the reaction region, before, during and/or after operation in order to reduce the oxygen content in the treatment tunnel. For this purpose, an oxygen-free purging gas is used in particular or a purging gas whose oxygen content is less than 1 vol.-%, preferably less than 0.3 vol.-%. Preferably, an inert gas such as argon or nitrogen is used as the purge gas. By introducing a purging gas into the treatment tunnel, in particular into the reaction region, reoxidation of the reduced workpiece surfaces can be reduced or even avoided, so that the apparatus can achieve an overall improved reduction of oxides on workpiece surfaces.

Suitable gas supply rates for purge gases are, for example, in the range of 1-30 1/min, preferably 5-15 l/min.

In particular, the purge gas supply may have a purge gas source for providing a purge gas, for example a gas cylinder with a purge gas, as well as a purge gas line through which the purge gas is introduced from the purge gas source into the reaction region.

It may be particularly advantageous for the purge gas supply to be configured to introduce purge gas into the treatment tunnel, in particular into the reaction region, before the plasma nozzle is operated. In this way, the treatment tunnel, in particular the reaction region, is purged, in particular essentially freed of oxygen, even before the workpiece surfaces are exposed to the atmospheric plasma jet, so that the reoxidation of the reduced workpiece surfaces is further reduced.

The purge gas supply may be configured to introduce the purge gas into the treatment tunnel, in particular into the reaction region, through a separate purge gas supply. The purge gas supply may also be configured to introduce the purge gas into the reaction region through a provided reduction gas inlet opening. In this way, reduction gas and purge gas may be introduced into the reaction region simultaneously or successively through the same reduction gas inlet opening. In particular, the reduction gas supply and the purge gas supply may be combined with one another, so that, for example, a gas supply is provided which is configured to introduce a reduction gas and/or a purge gas into the reaction region.

In a further embodiment, the plasma nozzle has a nozzle head from which the plasma jet emerges during operation and which rotates about an axis of rotation during operation.

During operation, the plasma jet emerges from the nozzle head, in particular at an oblique angle to the axis of rotation.

In this way, a larger area can be effectively covered with the plasma jet, so that a larger volume of gas can be excited with the plasma jet and, in particular, larger parts of the workpiece surfaces of the workpieces transported through the reaction region can be exposed to the plasma jet. In this way, a larger area of workpiece surfaces can be subjected to a reduction treatment in a shorter time.

In a further embodiment, a heating element and/or a cooling element are provided, which are configured to heat up and/or cool down the workpieces transported through the treatment tunnel.

By providing a heating element, in particular in an area of the treatment tunnel between the inlet opening and the reaction region, the workpiece can be preheated for the reduction treatment in the treatment chamber, which increases the reduction effect. In addition, by heating the workpiece, an improved depth effect of the reduction of oxides on the workpiece surfaces can be achieved, as the depth effect depends, among other things, on the diffusion of the atomic hydrogen into the workpiece surface, which is favored at a higher temperature.

By providing a cooling element, in particular in an area of the treatment tunnel between the reaction region and the outlet opening, the thermal energy introduced by the plasma treatment can be at least partially removed from the workpiece. In this way, the workpiece has a lower temperature when it comes into contact with oxygen again, whereby the reoxidation of the workpiece surfaces can be effectively reduced or even largely avoided. In particular, a lower workpiece surface temperature results in a lower oxidation rate of the workpiece surface.

The heating element and/or cooling element may be designed as active or passive elements. Furthermore, temperature control may be provided, in particular a controlled heating element and/or a controlled cooling element may be used. With controlled elements, the temperature of the heating elements may be set depending on the materials of the workpieces so that the melting point is not exceeded and degradation of the workpieces is prevented. This is particularly advantageous when reducing metal surfaces with a low melting point, such as tin.

In a further embodiment, the plasma nozzle or an optionally provided separate coating plasma nozzle is configured to provide workpieces, which, during operation, are transported through the reaction region and exposed to the atmospheric plasma jet in the reaction region, with a protective coating by means of plasma coating. For this purpose, a precursor feed is in particular provided, which is configured to introduce a precursor into the plasma jet generated by the plasma nozzle or the coating plasma nozzle.

In this way, the workpieces can, after the reduction of oxides on the workpiece surface, be provided with a protective layer by means of plasma coating by the plasma nozzle or the optionally further provided coating plasma nozzle in order to protect the reduced workpiece surface from oxidizing again.

The protective layer may be an organic layer, for example a hydrocarbon-containing layer, in particular a plastic layer. Preferably, the protective layer is an organosilicon protective layer. By covering the workpiece surface with an organic protective layer, oxygen can be kept away from the workpiece surface so that the formation of metal oxides with metal atoms of the workpiece surfaces is avoided.

The protective layer may also be an inorganic layer, in particular a silane layer or a metal or semiconductor oxide layer such as a TiO₂ or SiO₂ layer. It was found that oxidation of the metal of the workpiece surface can also be prevented by such a protective layer. In particular, it was found that the oxygen contained in the metal or semiconductor oxide layer as oxide does not tend to bind with the metal of the workpiece surface. A metal or semiconductor oxide layer can also provide good oxidation protection of the workpiece surface even at a very low layer thickness.

In order to prevent oxidation of the workpiece surface during the deposition of a metal or semiconductor oxide layer as a protective layer, it may be provided that the plasma nozzle or the optionally further provided coating plasma nozzle is configured to generate the plasma jet produced by the plasma nozzle or the coating plasma nozzle using an oxygen-free working gas. An oxygen-containing precursor may then be used to form the metal or semiconductor oxide layer, which is introduced, for example, into the plasma jet generated by the plasma nozzle or the coating plasma nozzle. It was found that the formation of the metal or semiconductor oxide layer from the precursor is so rapid that oxidation of the workpiece surface by the oxygen contained in the precursor practically does not occur.

The protective layer may be removed before a subsequent processing step or, alternatively, remain on the workpiece surface.

The application of a layer by means of plasma coating, in particular plasma polymerisation, is known in principle and therefore does not need to be described in detail here.

An organic or organosilicon precursor is preferably used to produce an organic, in particular organosilicon, protective layer.

Suitable precursors include hexamethyldisiloxane (HMDSO), tetraethyl orthosilicate (TEOS), 3-(trimethoxysilyl)propyl methacrylate (MEMO), octamethylcyclotetrasiloxane (D₄), decamethylcyclopentasiloxane (D₅), dodecamethylcyclohexasiloxane (D₆) and generally aminosilanes, trietoxysilanes, organosilanes, organosilanols, siloxanes, polysilazanes and carbosilanesilanes.

Other possible precursors are, in particular, functionalized organosilicon compounds with an epoxide group, such as 3-glycidoxypropyltrimethoxysilanes, with an acrylate group such as γ-methacryloxypropyl trimethoxysilane, with an amino group such as 3-aminopropyltrimethoxysilanes, 3-aminopropyltriethoxysilane or [3-(2-aminoethyl)aminopropyl]trimethoxysilane, with vinyl groups such as vinyltrimethoxysilane or 1,3-divinyltetramethyldisiloxane, with thiol groups such as (3-mercaptopropyl)trimethoxysilane or sulphane groups such as bis[3-(triethoxysilyl)propyl]tetrasulphide. Furthermore, purely organic, i.e. aliphatic, cyclic and aromatic precursors may also be used, such as heptane, 1-hexene, 1-octene, 1-heptine, 1,7-octadiene, 1,5-hexadiene, 1,5-cyclooctadiene, toluene, acetylene and xylenes.

In addition, a Si-based precursor that contains chemical Si—O bonds in combination with
a) an organic polar chain, in particular a hydroxyl, amino, carboxylic acid, imido, anhydrite, ester or epoxy chain, and/or
b) an organically non-polar chain, in particular a methyl, ethyl, propyl, vinyl or butyl chain, may be used.

Furthermore, metal alkoxides, in particular a Si, Ti, Zn, Al, Zr or Sr alkoxide, may be used as precursors, in particular for plasma coating with a metal oxide protective layer.

Provision with a protective layer may take place in the reaction region, for example. For this purpose, the plasma nozzle and the coating plasma nozzle may be operated alternately, for example. If the reduction treatment and the coating with a protective layer are carried out using one plasma nozzle, feeding of the precursor may be switched on and off alternately by means of the precursor feed, for example. The transport device may, for example, be configured to stop the transport of the workpieces in the reaction region so that reduction treatment and plasma coating can take place there one after the other.

Furthermore, a protective layer may also be applied in a separate coating region. For this purpose, in a further embodiment, a coating region is arranged between the reaction region and the outlet opening and the coating plasma nozzle is configured to provide workpieces, which are transported through the coating region during operation with the transport device, with a protective coating by means of plasma coating. In this way, continuous reduction treatment in the reduction region and continuous plasma coating in the coating region are made possible without the two treatments interfering with each other.

By providing a coating plasma nozzle in the coating region, the apparatus may be configured to simultaneously and independently perform a reduction treatment on workpieces and a plasma coating on workpieces that have already undergone a reduction treatment.

In particular, this allows continuous transport of workpieces through the treatment tunnel, preferably at a constant speed, and therefore simpler inline installation of the apparatus. Furthermore, contamination of the reaction region with precursor can be reduced in this way.

To further decouple the reduction treatment and plasma coating, the reaction region and the coating region are preferably spaced apart from each other. Preferably, the treatment tunnel in the area between the reaction region and the coating region has a reduced cross-section compared to the reaction region and/or the coating region.

In a further embodiment, the apparatus has a control device for controlling it. In particular, the control device may be configured to control the operation of the plasma nozzle and/or the optional coating plasma nozzle, the reduction gas supply and/or the optional purging gas supply, the transport device and/or the optional cooling and/or heating elements. In this way, the apparatus and the method can be automated so that handling is simplified and the reduction of oxides on workpiece surfaces can be standardised. Furthermore, automatic adjustment of process parameters, for example gas supply rates into the treatment tunnel, in particular into the reaction region, the transport speed of the workpieces through the reaction and/or coating region and/or the control of the heating and/or cooling elements on workpiece surfaces of different materials and the use of different gas mixtures can be achieved in this way. Overall, an effective reduction of oxides on workpiece surfaces of different materials can be achieved in this way.

### BRIEF DESCRIPTION OF THE DRAWINGS

Further features and advantages of the apparatus, the use and the method emerge from the following description of exemplary embodiments, with reference being made to the attached drawing.

In the drawing

FIG. 1 shows a plasma nozzle for generating an atmospheric plasma jet with a nozzle head that rotates around an axis of rotation during operation,

FIG. 2 shows a first exemplary embodiment of the apparatus and method for the reduction of oxides on workpiece surfaces and

FIG. 3 shows a second exemplary embodiment of the apparatus and method for the reduction of oxides on workpiece surfaces.

### DESCRIPTION OF THE INVENTION

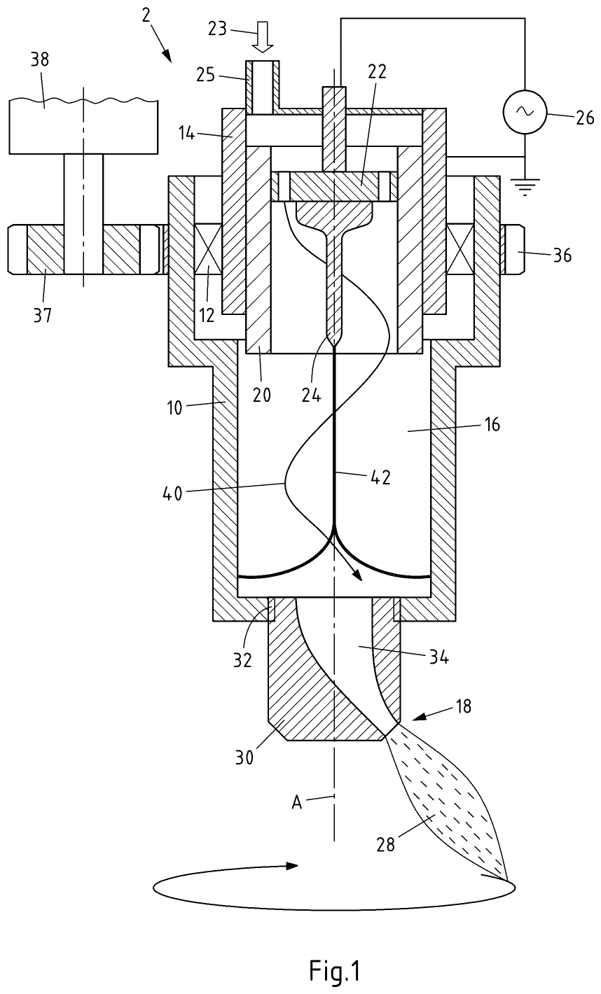

Before discussing a first exemplary embodiment of the apparatus described herein, the general structure and operating principle of a plasma nozzle suitable for the apparatus described herein will first be explained by means of the plasma nozzle shown in FIG. 1.

FIG. 1 shows a schematic sectional view of a plasma nozzle for generating a plasma jet by means of a high-frequency high-voltage discharge in the form of an arc-like discharge.

The plasma nozzle 2 has a tubular housing 10, which is enlarged in diameter in its-in the drawing-upper section and is rotatably mounted on a fixed support tube 14 with the aid of a bearing 12. Inside the housing 10, the upper part of a nozzle channel 16 is formed, which leads from the working gas supply 25 to a nozzle opening 18.

An electrically insulating ceramic tube 20 is inserted into the support tube 14. A working gas 23, for example a reduction gas, is fed through the working gas supply 25 and through the support tube 14 and the ceramic tube 20 into the nozzle channel 16. With the aid of a swirl device 22 inserted into the ceramic tube 20, the working gas 23 is swirled so that it flows in a vortex through the nozzle channel 16 in the direction of the nozzle opening 18, as symbolized in the drawing by a helical arrow 40. This creates a vortex core in the nozzle channel 16, which runs along the axis A of the housing 10.

A pin-shaped inner electrode 24 is mounted on the swirl device 22, which projects coaxially into the upper part of the nozzle channel 16 and to which a high-frequency high voltage is applied with the aid of a high-voltage generator 26. The high-frequency high voltage may have a voltage strength in the range of 1-100 kV, preferably 1-50 kV, more preferably 1-10 kV, and a frequency of 1-300 kHz, in particular 1-100 kHz, preferably 10-100 kHz, more preferably 10-50 kHz. The high-frequency high voltage may be a high-frequency alternating voltage, but also a pulsed direct voltage or a superposition of both voltage forms.

The metal housing 10 is grounded via the bearing 12 and the support tube 14 and serves as a counter-electrode, so that an electrical discharge 42 can be generated between the inner electrode 24 and the housing 10.

The inner electrode 24 arranged within the housing 10 is preferably aligned parallel to the axis A; in particular, the axis A may run through the inner electrode 24.

The nozzle opening 18 of the nozzle channel is formed by a nozzle head 30 made of metal, which is screwed into a threaded bore 32 of the housing 10 and in which a channel 34 is formed which tapers towards the nozzle opening 18, is curved and runs obliquely with respect to the axis A and forms the lower part of the nozzle channel 16 up to the nozzle opening 18. In this way, the plasma jet 28 emerging from the nozzle opening 18 forms an angle with the axis A of the housing, which in the example shown is approximately 45°. This angle may be varied as required by replacing the nozzle head 30.

The nozzle head 30 is thus arranged at the end of the discharge path of the high-frequency arc discharge 42 and is grounded via the metallic contact with the housing 10. The nozzle head 30 thus channels the outflowing gas and plasma jet 28, with the direction of the nozzle opening 18 running at a predetermined angle to the axis A.

Since the nozzle head 30 is connected to the housing 10 in a rotationally fixed manner and since the housing 10 is in turn rotatably mounted relative to the support tube 14 via the bearing 12, the nozzle head 30 can rotate relatively about the axis A. In this configuration, the axis of rotation therefore coincides with the housing axis A. A gear wheel 36 is arranged on the extended upper part of the housing 10, which is connected to a rotary drive 38, such as a motor, for example, via a toothed belt or a pinion 37.

During operation of the plasma nozzle 2, by the high-frequency high voltage, an arc discharge 42 is generated between the inner electrode 24 and the housing 10 due to the high frequency of the voltage. The arc of this high-frequency arc discharge is carried along by the swirled incoming working gas 23 and channeled in the core of the vortex-shaped gas flow, so that the arc 42 then runs almost in a straight line from the tip of the inner electrode 24 along the axis A and only branches radially onto the housing wall or onto the wall of the nozzle head 30 in the region of the lower end of the housing 10 or in the region of the channel 34. In this way, a plasma jet 28 is generated, which emerges through the nozzle opening 18.

The terms “arc” and “arc discharge” are used here as a phenomenological description of the discharge, as the discharge occurs in the form of an arc. The term “arc” is also used elsewhere as a form of discharge for DC discharges with essentially constant voltage values. In the present case, however, we are dealing with a high-frequency discharge in the form of an arc, i.e. a high-frequency arc discharge.

During operation, the housing 10 rotates at high speed around the axis A, so that the plasma jet 28 describes a conical surface which sweeps over the surface to be treated of a workpiece not shown. When a workpiece is then moved along the plasma nozzle 2, a relatively uniform treatment of the surface of the workpiece is achieved on a strip whose width corresponds to the diameter of the cone described by the plasma jet 28 on the workpiece surface. The width of the pre-treated area may be influenced by varying the distance between the nozzle head 30 and the workpiece. The plasma jet 28, which strikes the workpiece surface at an angle and is itself twisted, ensures that the plasma has an intensive effect on the workpiece surface. The direction of swirl of the plasma jet may be in the same or opposite direction to the direction of rotation of the housing 10. The intensity of the plasma treatment by the rotating plasma jet 28 depends on the distance between the nozzle opening 18 and the surface and on the angle of incidence of the plasma jet 28 on the surface to be treated as well as on the relative speed between the workpiece and the plasma nozzle 2.

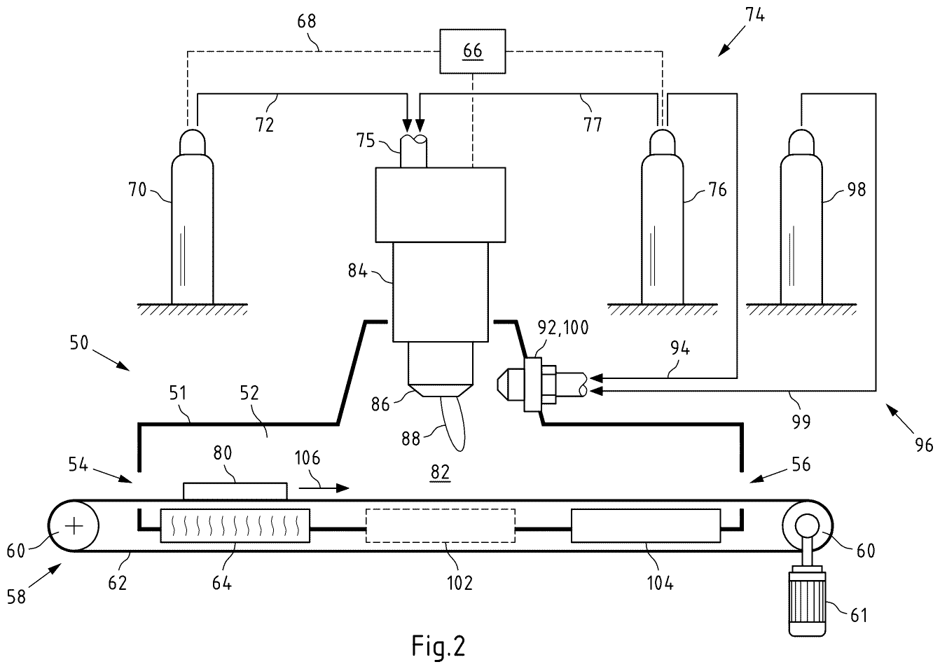

FIG. 2 shows a schematic view of a first exemplary embodiment of the apparatus and the method for the reduction of oxides on workpiece surfaces.

The apparatus 50 comprises a housing 51, for example made of metal, which surrounds a treatment tunnel 52, which has an inlet opening 54 to an outlet opening 56 for the entry or exit of workpieces 80. Furthermore, a transport device 58 is provided for transporting workpieces 80. In the present example, the transport device is in the form of a conveyor belt 62 which runs over drive rollers 60 driven by a motor 61.

In the treatment tunnel 52, a reaction region 82 is provided at a distance from the inlet opening 54 and the outlet opening 56, in which the treatment tunnel 52 has an enlarged cross-section. A plasma nozzle 84 is inserted into the housing 51 in the reaction region 82. The plasma nozzle 84 is arranged and configured in such a way that, during operation, an atmospheric plasma jet 88 generated by the plasma nozzle 84 is introduced into the reaction region 82, in particular during operation, workpieces 80 transported through the reaction region 82 are exposed to the atmospheric plasma jet 88 generated by the plasma nozzle 84. The plasma nozzle 84 may, for example, be designed like the plasma nozzle 2 of FIG. 1. Alternatively, the plasma nozzle 84 may also be designed as a non-rotating plasma nozzle, in which case the plasma jet may, for example, emerge from the nozzle opening in the longitudinal direction of the plasma nozzle. The plasma nozzle 84 has a working gas supply 75 (corresponding to the working gas supply 25 in FIG. 1) for supplying the plasma nozzle 84 with working gas.

The apparatus 50 also has a reduction gas supply 74, which is configured to introduce a reduction gas, for example forming gas, into the reaction region 82. For this purpose, the reduction gas supply 74 has a reduction gas source 76, which in the present example is designed as a gas cylinder.

The reduction gas supply 74 may be configured to supply the reduction gas to the plasma nozzle 84 as a working gas. For this purpose, a reduction gas line 77 may be provided, which guides the reduction gas from the reduction gas source 76 to the working gas supply 75. For example, a controllable valve for controlling the gas supply rate may be integrated into the reduction gas line 77.

In a conceivable variant of the exemplary embodiment, the reduction gas supply 74 is configured to introduce the reduction gas into the reaction region through a reduction gas inlet opening 92 separate from the plasma nozzle 84. For this purpose, a reduction gas line 94 may be provided to direct the reduction gas from the reduction gas source 76 to the reduction gas inlet port 92. For example, a controllable valve for controlling the gas supply rate may be integrated into the reduction gas line 94. In this variant, the working gas supply 75 may also be connected to the reduction gas source 76 or, alternatively, via a working gas line 72 to a working gas source 70 for providing a working gas, for example nitrogen or argon.

Furthermore, the apparatus 50 may have a purge gas supply 96, which is configured to introduce a purge gas into the treatment tunnel 52. For this purpose, the purge gas supply 96 has, in particular, a purge gas source 98 for providing an oxygen-free purge gas, for example nitrogen or argon, and a purge gas line 99 with which the purge gas is fed from the purge gas source 98 to a purge gas inlet opening 100 in the treatment tunnel 52. For example, a controllable valve for controlling the gas supply rate may be integrated into the purge gas line 99.

If the reduction gas supply 74 has a separate reduction gas inlet opening 92, this separate reduction gas inlet opening 92 may, for example, also be used as a purge gas inlet opening 100, as shown in FIG. 2. However, separate inlet openings are also conceivable.

If the reduction gas supply 74 does not have a separate reduction gas inlet opening 92, the inlet opening shown in FIG. 2 may be used alone as the purge gas inlet opening 100.

Furthermore, a heating element 64 is provided between the input opening 54 and the reaction region 82 and thus before the reaction region 82, in the transport direction 106 of the transport device 58, in order to preheat workpieces transported by the transport device 58 before they enter the reaction region 82.

Furthermore, a cooling element 104 is arranged between the reaction region 82 and the outlet opening 56 and thus behind the reaction region 82 in the transport direction 106 in order to cool workpieces transported by the transport device 58 after the reduction treatment in the reaction region 82. Furthermore, a heating and/or cooling element 102 may also be provided in the reaction region 82 itself.

The apparatus 50 further comprises a control device 66 for controlling it, which is connected via communication connections 68 (for the sake of clarity, not all connections are shown) to the plasma nozzle 84, to the gas sources 70, 76, 98 and to valves integrated in the gas lines 72, 77, 94, 99, respectively, and to the motor 61 of the transport device 58. The control device 66 is preferably configured to control gas supply rates at the gas supply lines 74, 96, the operation of the plasma nozzle 84, in particular the electrical power used for operation, the speed of the transport device 58 and optionally the temperature of the heating and cooling elements 64, 102, 104.

The operation of the apparatus 50 is described in the following.

Before starting the reduction treatment with the apparatus 50, a purge gas, for example nitrogen, is first introduced into the treatment tunnel 52 via the purge gas supply 96, for example via the purge gas inlet opening 100, so that any oxygen-containing atmosphere present there is purged out through the inlet or outlet opening 54, 56. Alternatively, the treatment tunnel 52 may also be purged with reduction gas, which may be introduced into the reaction region 82 via the reduction gas inlet 74.

The plasma nozzle 84 is then put into operation and an atmospheric plasma jet 88 is generated, which is introduced into the reaction region 82. With the reduction gas supply 74, a reduction gas is introduced into the reaction region 82, for example via the plasma nozzle 84 itself or via the optional reduction gas inlet opening 92. In this way, a reactive reducing atmosphere is created in the reaction region 82.

With the transport device 58, workpieces 80 are transported through the treatment tunnel 52, optionally preheated by the optional heating element 64 and transported through the reaction region 82, in which the reactive atmosphere present there acts on the workpiece surface by the reduction gas provided via the reduction gas supply 74 in the reaction region 82 and the plasma jet 88, resulting in a reduction of oxides on the workpiece surface. Preferably, the plasma nozzle 84 is aligned with the transport device 58 in such a way that the workpieces 80 in the reaction region 82 are exposed to the plasma jet 88, whereby an even more intensive reduction of oxides on the workpiece surface of the workpieces 80 is achieved.

The workpieces 80 may be transported through the reaction region 82 at a constant speed by the transport device 58. Alternatively, the transport device 58 may be configured to interrupt the transport for respective treatment durations when a workpiece 80 is in the reaction region 82.

Because the workpieces are transported further through the treatment tunnel 52 after the reaction region 82 and are optionally cooled there by the optional cooling element 104, reoxidation of the workpiece surface can be reduced or completely prevented.

In an optional variant of the exemplary embodiment, the plasma nozzle 84 may be configured to provide the workpieces 80 with a protective coating. For this purpose, a precursor feed line may be provided, for example in the area of the nozzle head 86 or at the working gas supply 75, via which a precursor can be introduced into the plasma jet 88. The plasma nozzle 84 may also be configured to work alternately in reduction mode and in coating mode, so that a workpiece 80 transported through the reaction region 82 is first subjected to a reduction treatment in reduction mode and then provided with a protective coating in coating mode with the addition of a precursor.

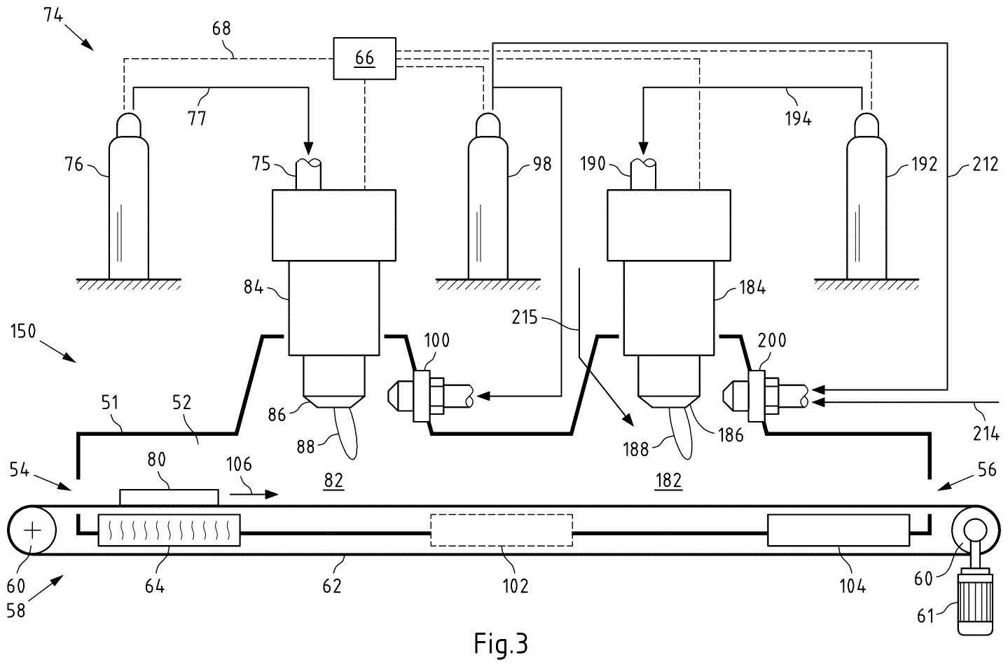

FIG. 3 shows a schematic view of a second exemplary embodiment of the apparatus and the method for the reduction of oxides on workpiece surfaces.

The apparatus 150 has a similar structure to the apparatus 50. Corresponding components are provided with the same reference signs and reference is made in this respect to the explanations above for FIG. 2.

The apparatus 150 differs from the apparatus 50 in that a coating region 182 spaced from the reaction region 82 is provided between the reaction region 82 and the output opening 56. In the coating region 182, a coating plasma nozzle 184 is integrated into the housing 51, which is configured to provide workpieces 80, which are transported through the coating region 182 during operation with the transport device 58, with a protective coating by means of plasma coating. For this purpose, a precursor feed 214 is provided, with which a precursor can be introduced into the atmospheric plasma jet 188 generated by the coating plasma nozzle 184 during operation. Furthermore, a purge gas line 212 is provided with which the purge gas is conducted from the purge gas source 98 to a purge gas inlet opening 200 in the treatment tunnel 52, in particular into the coating region 182.

In particular, the coating plasma nozzle 184 may have a similar structure to the plasma nozzle 2 of FIG. 1, to which reference is made here. Alternatively, the plasma nozzle 84 may also be designed as a non-rotating plasma nozzle, in which case the plasma jet may emerge from the nozzle opening in the longitudinal direction of the plasma nozzle, for example.

In the present example, the precursor feed 214 is configured to introduce the precursor together with the purge gas provided by the purge gas source 98 via the purge gas line 212 by means of the purge gas inlet opening 200 in the region of the nozzle head 186 of the coating plasma nozzle 184. Alternatively, a precursor feed 215 separate from the purge gas inlet opening 200 may be provided, which, for example, introduces the precursor directly at or into the coating plasma nozzle 184, preferably in the vicinity of its nozzle opening at the nozzle head 186. If a non-rotating coating plasma nozzle is used, this may, for example, have a precursor feed which guides the precursor laterally into the nozzle head 186.

In the exemplary embodiment shown in FIG. 3, the plasma nozzle 84 is supplied with a reduction gas as a working gas via the working gas supply 75. In the exemplary embodiment shown in FIG. 3, the coating plasma nozzle 184 is supplied via a working gas supply 190 with a working gas, for example nitrogen and/or argon, provided by a working gas source 192 via a working gas line 194.

Tests were carried out to compare the effectiveness of the reduction of oxides on metal workpiece surfaces under different process conditions using an apparatus 50 according to the exemplary embodiment of FIG. 2. The working gas used was a reduction gas containing nitrogen and hydrogen, which was supplied to the plasma nozzle 84 through the working gas supply 75 as a working gas and thus introduced into the reaction region 82. Nitrogen and argon were used as purge gases, with the purge gas being introduced into the reaction region 82 via the purge gas inlet opening 100.

In the tests, the proportion of the metal workpiece surface of metal workpieces present in oxidized form and the proportion present in metallic form were measured before and after treatment with the apparatus 50. It was found that treatment with the apparatus 50 effectively reduced the proportion of the metal workpiece surface present in oxidized form and effectively increased the proportion of the metal workpiece surface present in metallic form.

### LIST OF REFERENCE SYMBOLS

2,84 plasma nozzle
10 housing
12 bearing
14 support tube
16 nozzle channel
18 nozzle opening
20 ceramic tube
22 swirl device
23 working gas
24 inner electrode
25, 75, 190 working gas supply
26 high-voltage generator
28, 88, 188 plasma jet
30, 86, 186 nozzle head
32 threaded bore
34 channel
36 gear wheel
52 treatment tunnel
54 inlet opening
56 outlet opening
58 transport device
60 drive roller
61 motor
62 conveyor belt
64 heating element
66 control device
68 communication connections
70, 192 working gas source
72, 194 working gas line
74 reduction gas supply
76 reduction gas source
77,94 reduction gas line
80 workpiece
82 reaction region
92 reduction gas inlet opening
96 purge gas supply
98 purge gas source
99, 212 purge gas line
100, 200 purge gas inlet opening
102, 104 cooling element
106 transport direction
182 coating region
184 coating plasma nozzle
214, 215 precursor feed

1-14. (canceled)

15. An apparatus for the reduction of oxides on workpiece surfaces,
with a treatment tunnel extending from an inlet opening to an outlet opening,
with a reaction region arranged within the treatment tunnel,
with a plasma nozzle which is configured to generate an atmospheric plasma jet,
with a reduction gas supply configured to introduce a reduction gas into the reaction region, and
with a transport device configured to transport workpieces through the treatment tunnel,
wherein the plasma nozzle is arranged and configured in such a way as to introduce the atmospheric plasma jet into the reaction region during operation, and
wherein, between the inlet opening and the reaction region and/or between the reaction region and the outlet opening, the treatment tunnel has a reduced cross-section compared to the reaction region.

16. The apparatus according to claim 15, wherein the plasma nozzle is arranged and configured in such a way that workpieces transported through the treatment tunnel by the transport device during operation are exposed to the atmospheric plasma jet in the reaction region.

17. The apparatus according to claim 15,
wherein the reduction gas supply is configured to supply the reduction gas to the plasma nozzle as a working gas.

18. The apparatus according to claim 15,
wherein the reduction gas supply is configured to introduce the reduction gas into the reaction region through a reduction gas inlet opening separate from the plasma nozzle.

19. The apparatus to claim 15,
wherein a purge gas supply is provided, which is configured to introduce a purge gas into the treatment tunnel, in particular into the reaction region.

20. The apparatus according to claim 15,
wherein the plasma nozzle has a nozzle head from which the plasma jet emerges during operation and which rotates about an axis of rotation during operation.

21. The apparatus according to claim 15,
wherein a heating element and/or a cooling element are provided, which are configured to heat up and/or cool down the workpieces transported through the treatment tunnel.

22. The apparatus according to claim 15,
wherein the plasma nozzle or an optionally provided separate coating plasma nozzle is configured to provide workpieces, which are transported through the treatment tunnel and exposed to the atmospheric plasma jet in the reaction region during operation, with a protective coating by means of plasma coating.

23. The apparatus according to claim 22,
wherein a coating region is arranged between the reaction region and the outlet opening, and the coating plasma nozzle is configured to provide workpieces, which are transported through the treatment tunnel with the transport device during operation, with a protective coating in the coating region by means of plasma coating.

24. A method of reducing oxides on workpiece surfaces, including the step of using an apparatus according to claim 15.

25. A method for the reduction oxides on workpiece surfaces with an apparatus according to claim 15,
in which one or more workpieces are transported through the treatment tunnel by the transport device,
in which an atmospheric plasma jet is generated with the plasma nozzle,
in which a reduction gas is introduced into the reaction zone, and
in which the atmospheric plasma jet is introduced into the reaction region.

26. A method according to claim 25,
wherein the one or more workpieces transported through the treatment tunnel are exposed to the atmospheric plasma jet in the reaction region.

27. The method according to claim 25,
wherein the reduction gas is introduced into the plasma nozzle as a working gas.

28. The method according to claim 25,
wherein the reduction gas is introduced into the reaction region via a reduction gas inlet opening separate from the plasma nozzle.
